(19) United States
(12) Patent Application Publication
(10) Pub. No.: US 2026/0213030 A1
(43) Pub. Date: Jul. 23, 2026

(54) PLANT CONTROL SYSTEM

(71) Applicant: Mitsubishi Electric Corporation, Chiyoda-ku, Tokyo (JP)

(72) Inventor: Susumu OKUDA, Chiyoda-ku, Tokyo (JP)

(73) Assignee: Mitsubishi Electric Corporation, Chiyoda-ku, Tokyo (JP)

(21) Appl. No.: 19/138,357

(22) PCT Filed: Mar. 10, 2023
(86) PCT No.: PCT/JP2023/009264

§ 371 Date: Jun. 12, 2025

(51) Int. Cl. G21D 3/06; G21D 3/00; G21D 3/02

(52) U.S. Cl. CPC G21D 3/06; G21D 3/008; G21D 3/02

(57) ABSTRACT

Provided is a control system that has a simple configuration and can assuredly shut off an operation signal from a regular-system operation terminal. A control system includes: a safety-system operation terminal for an operator to perform monitoring and operation for safety-system equipment; a regular-system operation terminal for performing monitoring and operation for regular-system equipment and the safety-system equipment; a control unit to which operation signals from the safety-system operation terminal and the regular-system operation terminal are inputted, and which outputs a control signal to plant equipment; a safety system network; and a regular system network. The control unit has a function of disabling the operation signal transmitted from the regular system network when the monitoring and operation are performed from the safety-system operation terminal.

### TECHNICAL FIELD

The present disclosure relates to a plant control system.

### BACKGROUND ART

A control system for controlling a plant such as a nuclear power plant is required to have a function of leading the plant into a safe state when abnormality has occurred in the plant. Therefore, the plant control system is composed of a regular system which performs normal operation of the plant, and a safety system which leads the plant into a safe state. Such a control system is provided with a regular-system operation terminal corresponding to a regular system, and a safety-system operation terminal corresponding to a safety system. When the plant performs normal operation, an operator transmits an operation signal to regular-system equipment, e.g., a pump, a valve, and a circuit breaker, using the regular-system operation terminal, to perform monitoring and operation for the plant. When abnormality has occurred in the plant, an operator transmits an operation signal to safety-system equipment, e.g., a cooler and a disconnector, using the safety-system operation terminal, to perform monitoring and operation for the plant.

In normal operation, an operator performs monitoring and operation for the plant using the regular-system operation terminal, but when abnormality has occurred, an operator needs to operate the safety-system operation terminal different from the regular-system operation terminal. Thus, there is a problem that monitoring and operation for the plant are complicated.

In order to address such a problem, one conventional plant control system is configured such that the regular-system operation terminal is also imparted with an additional function of transmitting an operation signal to safety-system equipment. In this control system, when abnormality has occurred in the plant, an operator can transmit an operation signal to safety-system equipment from the regular-system operation terminal. When the regular-system operation terminal has failed and cannot be operated, an operator transmits an operation signal to safety-system equipment from the safety-system operation terminal. At this time, an operation signal from the regular-system operation terminal to safety-system equipment is shut off (see, for example, Patent Document 1 and Patent Document 2).

### CITATION LIST

### Patent Document

Patent Document 1: Japanese Laid-Open Patent Publication No. 2012-78167

Patent Document 2: Japanese Laid-Open Patent Publication No. 2012-103013

### SUMMARY OF THE INVENTION

### Problem to be Solved by the Invention

In the conventional plant control system, a separation circuit is provided on a path through which an operation signal is transmitted from the regular-system operation terminal to each device of safety-system equipment. When an operator transmits an operation signal to each device of safety-system equipment from the safety-system operation terminal, an operation signal from the regular-system operation terminal to safety-system equipment is shut off using the separation circuit. Therefore, in the conventional plant control system, separation circuits need to be provided in accordance with the number of devices of safety-system equipment, thus causing a problem that the apparatus is complicated and is increased in size. In a case of implementing a separation circuit by software, size increase in the apparatus can be avoided, but separation circuits (logic circuits) implemented by software are needed in accordance with the number of devices of safety-system equipment, thus causing a problem that software is complicated.

The present disclosure has been made to solve the above problems, and an object of the present disclosure is to provide a control system that has a simple configuration and can assuredly shut off an operation signal from a regular-system operation terminal to safety-system equipment when an operator transmits an operation signal from a safety-system operation terminal to safety-system equipment, while separation circuits need not be provided in accordance with the number of devices of safety-system equipment.

### Means to Solve the Problem

A plant control system according to the present disclosure includes: a safety-system operation terminal for performing monitoring and operation for safety-system equipment; a regular-system operation terminal for performing monitoring and operation for regular-system equipment and the safety-system equipment; a control unit to which operation signals from the safety-system operation terminal and the regular-system operation terminal are inputted, and which outputs a control signal to plant equipment including the safety-system equipment and the regular-system equipment; a safety system network which transmits the operation signal from the safety-system operation terminal to the control unit; and a regular system network which transmits the operation signal from the regular-system operation terminal to the control unit. The control unit has a function of disabling the operation signal transmitted from the regular system network when the monitoring and operation for the safety-system equipment are performed from the safety-system operation terminal.

### EFFECT OF THE INVENTION

In the plant control system according to the present disclosure, since the control unit has the function of disabling the operation signal transmitted from the regular system network when the monitoring and operation for the safety-system equipment are performed from the safety-system operation terminal, the configuration of the control system is simplified.

### BRIEF DESCRIPTION OF THE DRAWINGS

FIG. 1 is a configuration diagram of a plant control system according to embodiment 1.

FIG. 2 is a configuration diagram of a control unit of the plant control system according to embodiment 1.

FIG. 3 is a flowchart showing operation of a calculation module of the plant control system according to embodiment 1.

FIG. 4 is a configuration diagram of a plant control system according to embodiment 2.

FIG. 5 is a configuration diagram of a control unit of the plant control system according to embodiment 2.

FIG. 6 is a flowchart showing operation of a calculation module of the plant control system according to embodiment 2.

FIG. 7 is a configuration diagram of a plant control system according to embodiment 3.

FIG. 8 shows an example of a hardware configuration of the control unit of the plant control system according to each of embodiments 1 to 3.

### DESCRIPTION OF EMBODIMENTS

Hereinafter, plant control systems according to embodiments for carrying out the present disclosure will be described in detail with reference to the drawings. In the drawings, the same reference characters denote the same or corresponding parts.

### Embodiment 1

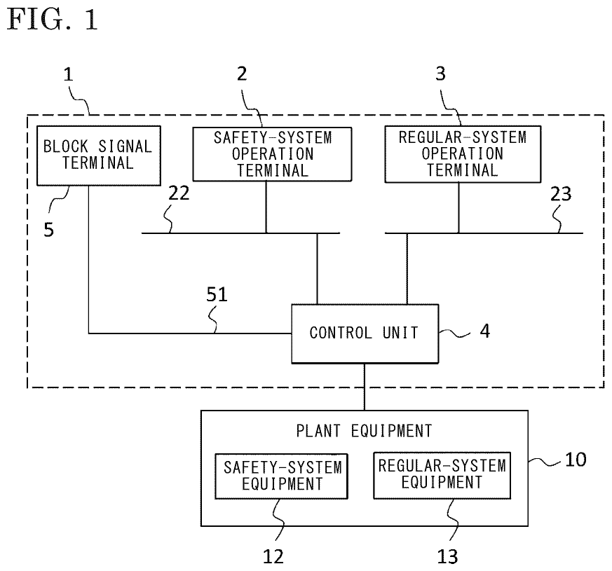

FIG. 1 is a configuration diagram of a plant control system according to embodiment 1. A plant control system 1 according to the present embodiment includes a safety-system operation terminal 2, a regular-system operation terminal 3, a control unit 4, and a block signal terminal 5. The control system 1 is a system for controlling plant equipment 10 including safety-system equipment 12 and regular-system equipment 13. The plant equipment 10 is plant equipment composing a nuclear power plant, for example. The safety-system equipment 12 includes a cooler, a disconnector, and the like, for example. The regular-system equipment 13 includes a pump, a valve, a circuit breaker, and the like, for example.

The safety-system operation terminal 2 is a terminal for an operator to perform monitoring and operation for the safety-system equipment 12 of the plant equipment 10. The safety-system operation terminal 2 is connected to the control unit 4 via a safety system network 22. The safety-system operation terminal 2 transmits an operation signal to the control unit 4 via the safety system network 22, and receives information about the safety-system equipment 12 from the control unit 4 via the safety system network 22.

The regular-system operation terminal 3 is a terminal for an operator to perform monitoring and operation for the safety-system equipment 12 and the regular-system equipment 13 of the plant equipment 10. The regular-system operation terminal 3 is connected to the control unit 4 via a regular system network 23. The regular-system operation terminal 3 transmits an operation signal to the control unit 4 via the regular system network 23, and receives information about the safety-system equipment 12 and the regular-system equipment 13 from the control unit 4 via the regular system network 23. The safety system network 22 and the regular system network 23 are independent of each other. However, the safety system network 22 and the regular system network 23 may not necessarily be independent of each other.

As the safety-system operation terminal 2 and the regular-system operation terminal 3, a video display unit (VDU) is used, for example. The VDU is a terminal device for operating a computer and has a display function of displaying an image to be presented to a user from the computer and an input function of receiving an order to instruct the computer from a user. Examples of the VDU include a tablet, a smartphone, and a stationary touch panel display.

The control unit 4 receives operation signals from the safety-system operation terminal 2 and the regular-system operation terminal 3. The control unit 4 generates a control signal for the plant equipment 10 on the basis of the operation signals inputted from the safety-system operation terminal 2 and the regular-system operation terminal 3, and transmits the generated control signal to the plant equipment 10.

The block signal terminal 5 is provided separately from the safety-system operation terminal 2 and the regular-system operation terminal 3. The block signal terminal 5 is connected to the control unit 4 via a wire 51. The block signal terminal 5 is provided for an operator to transmit a block signal when the operator cannot perform monitoring and operation for the plant equipment 10 by the regular-system operation terminal 3, e.g., when the regular-system operation terminal 3 has failed. The block signal terminal 5 transmits a block signal to the control unit 4 in accordance with operation by an operator. The block signal terminal 5 is, for example, an analog switch.

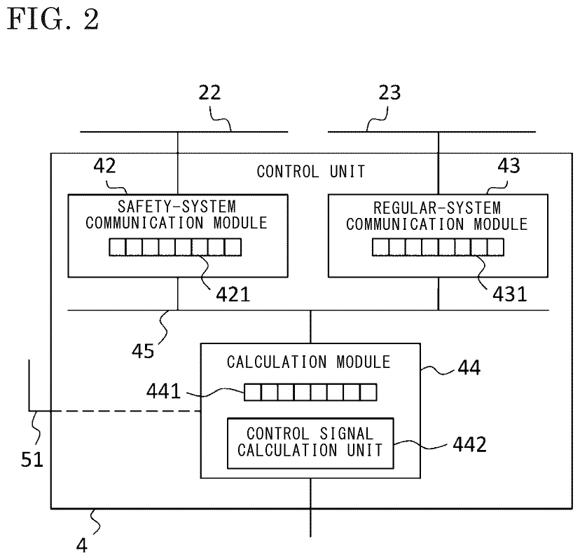

FIG. 2 is a configuration diagram of the control unit of the plant control system according to the present embodiment. The control unit 4 in the present embodiment includes a safety-system communication module 42, a regular-system communication module 43, and a calculation module 44. An operation signal sent from the safety system network 22 is received by the safety-system communication module 42. The safety-system communication module 42 stores the received operation signal in an internal safety-system communication memory 421. An operation signal sent from the regular system network 23 is received by the regular-system communication module 43. The regular-system communication module 43 stores the received operation signal in an internal regular-system communication memory 431.

The calculation module 44 is connected to the safety-system communication module 42 and the regular-system communication module 43 via an internal network 45. The calculation module 44 reads data from the safety-system communication memory 421 and the regular-system communication memory 431 at regular intervals, and stores the read data in an internal calculation memory 441. The calculation module 44 calculates a control signal for controlling the plant equipment 10, by an internal control signal calculation unit 442, on the basis of data stored in the calculation memory 441. The control unit 4 outputs the control signal calculated by the calculation module 44 to the plant equipment 10.

The control unit 4 is connected to the block signal terminal 5 via the wire 51, and the block signal is inputted to the calculation module 44. As described later, the calculation module 44 selects data to be stored in the calculation memory 441, on the basis of input of the block signal.

Next, operation of the plant control system 1 according to the present embodiment will be described.

When the plant equipment 10 is operating normally, operation of the plant equipment 10 is performed with monitoring and operation by an operator using the regular-system operation terminal 3. When abnormality has occurred in the plant equipment 10, an operator needs to lead the plant equipment 10 into a safe state by performing monitoring and operation for the safety-system equipment 12. Since the regular-system operation terminal 3 has functions of performing monitoring and operation for both of the safety-system equipment 12 and the regular-system equipment 13 of the plant equipment 10, an operator can immediately cope with abnormality using the regular-system operation terminal 3.

When an operator cannot perform monitoring and operation for the plant equipment 10 by the regular-system operation terminal 3, e.g., when the regular-system operation terminal 3 has failed, the operator needs to lead the plant equipment 10 into a safe state by the safety-system operation terminal 2. In this case, the operator operates the block signal terminal 5 to transmit a block signal to the control unit 4, and operates the safety-system operation terminal 2 to transmit an operation signal for the safety-system equipment 12 to the control unit 4. At this time, an operation signal from the regular-system operation terminal 3 to the safety-system equipment 12 needs to be shut off. This is because, depending on the condition of failure of the regular-system operation terminal 3, an erroneous operation signal might be transmitted from the regular-system operation terminal 3 to the safety-system equipment 12.

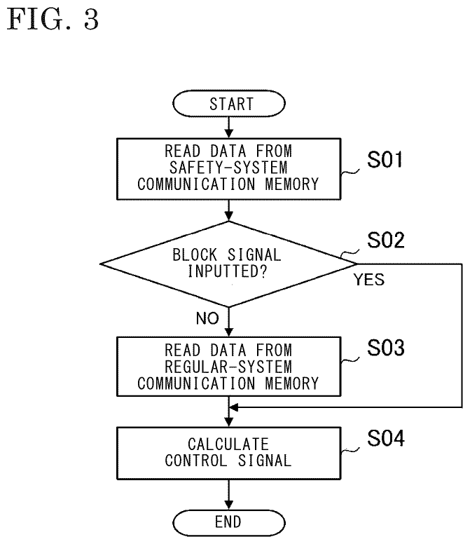

FIG. 3 is a flowchart showing operation of the calculation module of the plant control system according to the present embodiment. In step S01, the calculation module 44 reads data from the safety-system communication memory 421. Next, in step S02, the calculation module 44 confirms whether or not a block signal is inputted. In step S02, if a block signal is not inputted (NO), the calculation module 44 proceeds to step S03. In step S03, the calculation module 44 reads data from the regular-system communication memory 431. Next, the calculation module 44 proceeds to step S04. In step S02, if a block signal is inputted (YES), the calculation module 44 proceeds to step S04.

In step S04, the calculation module 44 stores the read data in the calculation memory 441. Then, the calculation module 44 calculates a control signal for controlling the plant equipment 10 by the internal control signal calculation unit 442, on the basis of data stored in the calculation memory 441. The control unit 4 outputs the control signal calculated by the calculation module 44 to the plant equipment 10.

In the plant control system configured as described above, when a block signal is inputted, transfer of data from the regular-system communication module 43 to the calculation module 44 is stopped, whereby an operation signal transmitted from the regular system network 23 is disabled. Therefore, in this control system, when an operation signal is transmitted from the safety-system operation terminal 2 to the safety-system equipment 12, an operation signal from the regular-system operation terminal 3 to the safety-system equipment 12 can be assuredly shut off. In this control system, it is not necessary to provide separation circuits for operation signals transmitted from the regular-system operation terminal 3 in accordance with the number of devices of the safety-system equipment 12, so that the configuration is simplified.

In the plant control system according to the present embodiment, in a case where the safety system network 22 and the regular system network 23 are independent of each other, an operation signal is assuredly transmitted to the safety-system equipment 12 through the safety system network 22 even if the regular system network 23 is shut off for an unexpected reason.

In the plant control system according to the present embodiment, when a block signal is inputted, the calculation module 44 does not read data from the regular-system communication memory 431. In this case, data in an area into which data is to be read from the regular-system communication memory 431 in the calculation memory 441 may be changed to predetermined data, or data read before a block signal is inputted may be retained, for example.

As described above, the plant control system according to the present embodiment includes: a safety-system operation terminal for performing monitoring and operation for safety-system equipment; a regular-system operation terminal for performing monitoring and operation for regular-system equipment and the safety-system equipment; a control unit to which operation signals from the safety-system operation terminal and the regular-system operation terminal are inputted, and which outputs a control signal to plant equipment including the safety-system equipment and the regular-system equipment; a safety system network which transmits the operation signal from the safety-system operation terminal to the control unit; and a regular system network which transmits the operation signal from the regular-system operation terminal to the control unit. The control unit has a function of disabling the operation signal transmitted from the regular system network when the monitoring and operation for the safety-system equipment are performed from the safety-system operation terminal.

In the plant control system configured as described above, when an operation signal is transmitted from the safety-system operation terminal to the safety-system equipment, an operation signal from the regular-system operation terminal to the safety-system equipment can be assuredly shut off, and the configuration is simplified.

### Embodiment 2

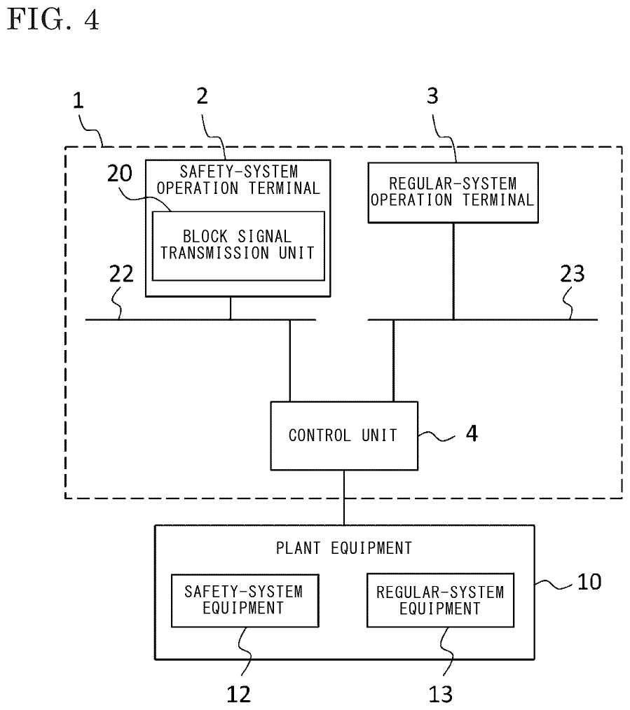

FIG. 4 is a configuration diagram of a plant control system according to embodiment 2. The plant control system 1 according to the present embodiment includes the safety-system operation terminal 2, the regular-system operation terminal 3, and the control unit 4. The control system 1 is a system for controlling the plant equipment 10 including the safety-system equipment 12 and the regular-system equipment 13. The plant equipment 10 is plant equipment composing a nuclear power plant, for example.

The safety-system operation terminal 2 is a terminal for an operator to perform monitoring and operation for the safety-system equipment 12 of the plant equipment 10. The safety-system operation terminal 2 is connected to the control unit 4 via the safety system network 22. The safety-system operation terminal 2 transmits an operation signal to the control unit 4 via the safety system network 22, and receives information about the safety-system equipment 12 from the control unit 4 via the safety system network 22.

The regular-system operation terminal 3 is a terminal for an operator to perform monitoring and operation for the safety-system equipment 12 and the regular-system equipment 13 of the plant equipment 10. The regular-system operation terminal 3 is connected to the control unit 4 via the regular system network 23. The regular-system operation terminal 3 transmits an operation signal to the control unit 4 via the regular system network 23, and receives information about the safety-system equipment 12 and the regular-system equipment 13 from the control unit 4 via the regular system network 23. The safety system network 22 and the regular system network 23 are independent of each other. However, the safety system network 22 and the regular system network 23 may not necessarily be independent of each other.

The control unit 4 receives an operation signal from the safety-system operation terminal 2 and the regular-system operation terminal 3. The control unit 4 generates a control signal for the plant equipment 10 on the basis of the operation signals inputted from the safety-system operation terminal 2 and the regular-system operation terminal 3, and transmits the generated control signal to the plant equipment 10.

In the plant control system according to the present embodiment, the safety-system operation terminal 2 includes a block signal transmission unit 20. The block signal transmission unit 20 is provided for an operator to transmit a block signal when the operator cannot perform monitoring and operation for the plant equipment 10 by the regular-system operation terminal 3, e.g., when the regular-system operation terminal 3 has failed. The block signal transmission unit 20 transmits a block signal to the control unit 4 via the safety system network 22 in accordance with operation by an operator.

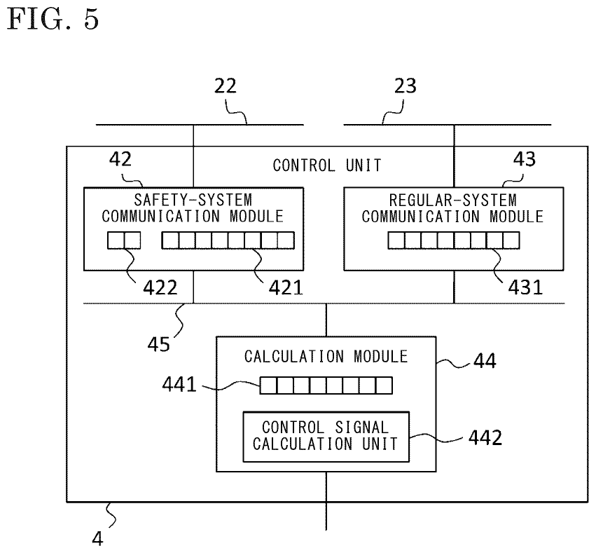

FIG. 5 is a configuration diagram of the control unit of the plant control system according to the present embodiment. The control unit 4 in the present embodiment includes the safety-system communication module 42, the regular-system communication module 43, and the calculation module 44. An operation signal sent from the safety system network 22 is received by the safety-system communication module 42. The safety-system communication module 42 stores the received operation signal in the internal safety-system communication memory 421. In addition, the safety-system communication module 42 stores a block signal sent via the safety system network 22, in an internal block signal memory 422. An operation signal sent from the regular system network 23 is received by the regular-system communication module 43. The regular-system communication module 43 stores the received operation signal in the internal regular-system communication memory 431.

The calculation module 44 is connected to the safety-system communication module 42 and the regular-system communication module 43 via the internal network 45. The calculation module 44 reads data from the safety-system communication memory 421 and the regular-system communication memory 431 at regular intervals, and stores the read data in an internal calculation memory 441. In addition, the calculation module 44 reads data in the block signal memory 422 of the safety-system communication module 42, and determines whether or not a block signal is inputted from the safety-system operation terminal 2. The calculation module 44 calculates a control signal for controlling the plant equipment 10, by the internal control signal calculation unit 442, on the basis of data stored in the calculation memory 441. The control unit 4 outputs the control signal calculated by the calculation module 44 to the plant equipment 10.

Next, operation of the plant control system 1 according to the present embodiment will be described.

When the plant equipment 10 is operating normally, operation of the plant equipment 10 is performed with monitoring and operation by an operator using the regular-system operation terminal 3. When abnormality has occurred in the plant equipment 10, an operator needs to lead the plant equipment 10 into a safe state by performing monitoring and operation for the safety-system equipment 12. Since the regular-system operation terminal 3 has functions of performing monitoring and operation for both of the safety-system equipment 12 and the regular-system equipment 13 of the plant equipment 10, an operator can immediately cope with abnormality using the regular-system operation terminal 3.

When an operator cannot perform monitoring and operation for the plant equipment 10 by the regular-system operation terminal 3, e.g., when the regular-system operation terminal 3 has failed, the operator needs to lead the plant equipment 10 into a safe state by the safety-system operation terminal 2. In this case, the operator operates the safety-system operation terminal 2 to transmit a block signal from the block signal transmission unit 20 to the control unit 4, and operates the safety-system operation terminal 2 to transmit an operation signal for the safety-system equipment 12 to the control unit 4. At this time, an operation signal from the regular-system operation terminal 3 to the safety-system equipment 12 needs to be shut off.

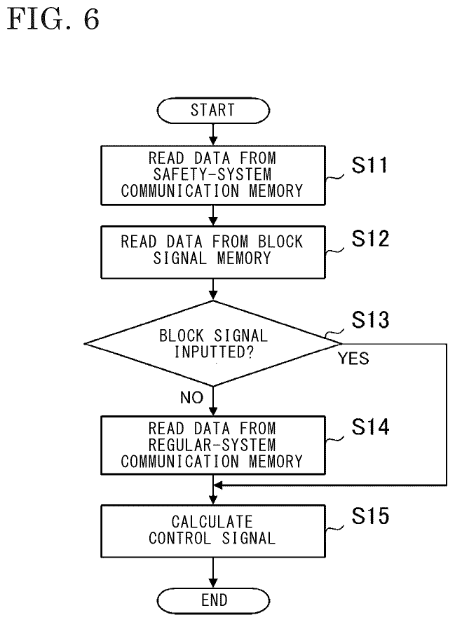

FIG. 6 is a flowchart showing operation of the calculation module of the plant control system according to the present embodiment. In step S11, the calculation module 44 reads data from the safety-system communication memory 421. Next, in step S12, the calculation module 44 reads data from the block signal memory 422. Next, in step S13, the calculation module 44 confirms whether or not a block signal is inputted. In step S13, if a block signal is not inputted (NO), the calculation module 44 proceeds to step S14. In step S14, the calculation module 44 reads data from the regular-system communication memory 431. Next, the calculation module 44 proceeds to step S15. In step S13, if a block signal is inputted (YES), the calculation module 44 proceeds to step S15.

In step S15, the calculation module 44 stores the read data in the calculation memory 441. Then, the calculation module 44 calculates a control signal for controlling the plant equipment 10 by the internal control signal calculation unit 442, on the basis of data stored in the calculation memory 441. The control unit 4 outputs the control signal calculated by the calculation module 44 to the plant equipment 10.

In the plant control system configured as described above, when a block signal is inputted, transfer of data from the regular-system communication module 43 to the calculation module 44 is stopped, whereby an operation signal transmitted from the regular system network 23 is disabled. Therefore, in this control system, when an operation signal is transmitted from the safety-system operation terminal 2 to the safety-system equipment 12, an operation signal from the regular-system operation terminal 3 to the safety-system equipment 12 can be assuredly shut off. In this control system, it is not necessary to provide separation circuits for operation signals transmitted from the regular-system operation terminal 3 in accordance with the number of devices of the safety-system equipment 12, so that the configuration is simplified.

In the plant control system according to the present embodiment, since the safety-system operation terminal 2 includes the block signal transmission unit 20, it is not necessary to provide a block signal terminal separately from the safety-system operation terminal 2. Thus, the plant control system according to the present embodiment has a more simplified configuration than the plant control system according to embodiment 1.

In the plant control system according to the present embodiment, when a block signal is inputted, transfer of data from the regular-system communication module 43 to the calculation module 44 is merely stopped. Therefore, it is not necessary to provide separation circuits (logic circuits) implemented by software in accordance with the number of devices of safety-system equipment. Thus, the configuration of the plant control system according to the present embodiment is simplified also in terms of software.

In the plant control system according to the present embodiment, when a block signal is inputted, the calculation module 44 does not read data from the regular-system communication memory 431. In this case, data in an area into which data is to be read from the regular-system communication memory 431 in the calculation memory 441 may be changed to predetermined data, or data read before a block signal is inputted may be retained, for example.

### Embodiment 3

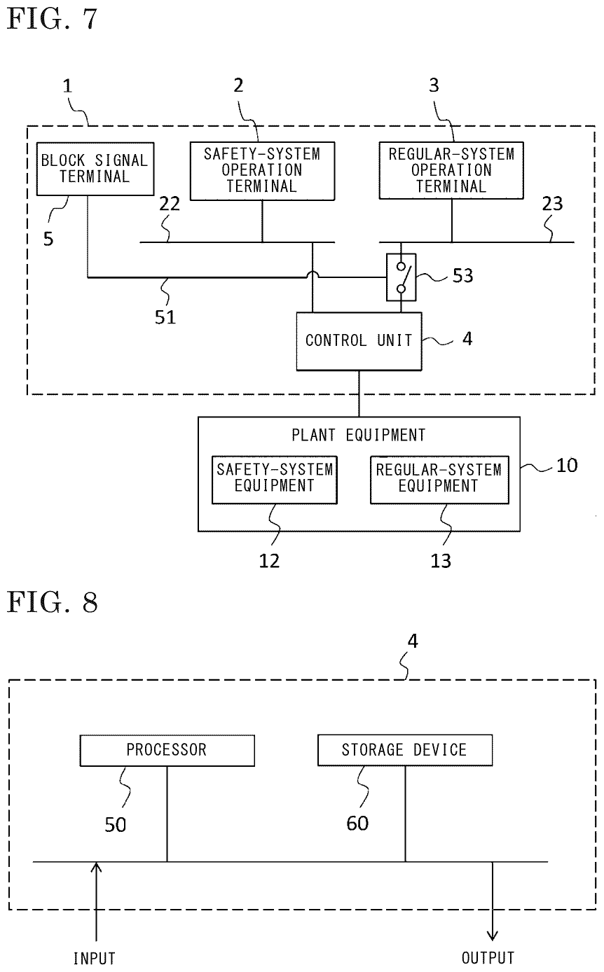

FIG. 7 is a configuration diagram of a plant control system according to embodiment 3. The plant control system 1 according to the present embodiment includes the safety-system operation terminal 2, the regular-system operation terminal 3, the control unit 4, and the block signal terminal 5. The control system 1 is a system for controlling the plant equipment 10 including the safety-system equipment 12 and the regular-system equipment 13. The plant equipment 10 is plant equipment composing a nuclear power plant, for example.

The safety-system operation terminal 2 is a terminal for an operator to perform monitoring and operation for the safety-system equipment 12 of the plant equipment 10. The safety-system operation terminal 2 is connected to the control unit 4 via the safety system network 22. The safety-system operation terminal 2 transmits an operation signal to the control unit 4 via the safety system network 22, and receives information about the safety-system equipment 12 from the control unit 4 via the safety system network 22.

The regular-system operation terminal 3 is a terminal for an operator to perform monitoring and operation for the safety-system equipment 12 and the regular-system equipment 13 of the plant equipment 10. The regular-system operation terminal 3 is connected to the control unit 4 via the regular system network 23. The regular-system operation terminal 3 transmits an operation signal to the control unit 4 via the regular system network 23, and receives information about the safety-system equipment 12 and the regular-system equipment 13 from the control unit 4 via the regular system network 23. The safety system network 22 and the regular system network 23 are independent of each other.

The control unit 4 receives an operation signal from the safety-system operation terminal 2 and the regular-system operation terminal 3. The control unit 4 generates a control signal for the plant equipment 10 on the basis of the operation signals inputted from the safety-system operation terminal 2 and the regular-system operation terminal 3, and transmits the generated control signal to the plant equipment 10. The configuration of the control unit 4 is the same as the configuration of the control unit shown in FIG. 2 in embodiment 1.

The block signal terminal 5 is provided separately from the safety-system operation terminal 2 and the regular-system operation terminal 3. The block signal terminal 5 is connected to a separation circuit 53 via the wire 51. The separation circuit 53 is provided to the regular system network 23. The separation circuit 53 has a function of electrically disconnecting the regular system network 23. When a block signal is inputted from the block signal terminal 5, the separation circuit 53 shuts off transmission of an operation signal on the regular system network 23. The block signal terminal 5 is provided for an operator to transmit a block signal when the operator cannot perform monitoring and operation for the plant equipment 10 by the regular-system operation terminal 3, e.g., when the regular-system operation terminal 3 has failed. The block signal terminal 5 transmits a block signal to the separation circuit 53 in accordance with operation by an operator.

When an operator cannot perform monitoring and operation for the plant equipment 10 by the regular-system operation terminal 3, e.g., when the regular-system operation terminal 3 has failed, the operator needs to lead the plant equipment 10 into a safe state by the safety-system operation terminal 2. In this case, the operator operates the block signal terminal 5 to transmit a block signal to the separation circuit 53, and operates the safety-system operation terminal 2 to transmit an operation signal for the safety-system equipment 12 to the control unit 4. When a block signal is inputted from the block signal terminal 5, the separation circuit 53 shuts off transmission of an operation signal on the regular system network 23.

In the plant control system configured as described above, when a block signal is inputted, the separation circuit 53 disconnects the regular system network 23, whereby an operation signal transmitted from the regular system network 23 is disabled. Therefore, in this control system, when an operation signal is transmitted from the safety-system operation terminal 2 to the safety-system equipment 12, an operation signal from the regular-system operation terminal 3 to the safety-system equipment 12 can be assuredly shut off. In this control system, operation signals to be transmitted from the regular-system operation terminal 3 to the safety-system equipment 12 can be all shut off by one separation circuit, and thus the configuration is simplified.

In the plant control system according to the present embodiment, when a block signal is inputted, an operation signal from the regular-system operation terminal 3 is not inputted to the control unit 4. Therefore, in the calculation module 44 of the control unit 4, data read before a block signal is inputted is retained. In a case where the control unit 4 can recognize that a block signal is inputted to the separation circuit 53, the calculation module 44 may change data in an area into which data is to be read from the regular-system communication memory 431 in the calculation memory 441, to predetermined data.

The control unit 4 of the plant control system according to each of embodiments 1 to 3 is composed of a processor 50 and a storage device 60, as shown in a hardware example in FIG. 8. The storage device 60 is provided with a volatile storage device such as a random access memory and a nonvolatile auxiliary storage device such as a flash memory, although not shown. Instead of the flash memory, an auxiliary storage device of a hard disk may be provided. The processor 50 may include a central processing unit (CPU), an application specific integrated circuit (ASIC), an integrated circuit (IC), a field programmable gate array (FPGA), various logic circuits, and various signal processing circuits, for example. As the processor 50, a plurality of processors that are the same kind or different kinds may be provided and each process may be executed in a shared manner among the processors.

The processor 50 executes a program inputted from the storage device 60. In this case, the program is inputted from the auxiliary storage device to the processor 50 via the volatile storage device. The processor 50 may output data such as a calculation result to the volatile storage device of the storage device 60 or may store such data into the auxiliary storage device via the volatile storage device.

Although the disclosure is described above in terms of various exemplary embodiments, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 control system
2 safety-system operation terminal
3 regular-system operation terminal
4 control unit
5 block signal terminal
10 plant equipment
12 safety-system equipment
13 regular-system equipment
20 block signal transmission unit
22 safety system network
23 regular system network
42 safety-system communication module
43 regular-system communication module
44 calculation module
45 internal network
50 processor
51 wire
53 separation circuit
60 storage device
421 safety-system communication memory
422 block signal memory
431 regular-system communication memory
441 calculation memory
442 control signal calculation unit

1. A plant control system comprising:
a safety-system operation terminal for performing monitoring and operation for safety-system equipment;
a regular-system operation terminal for performing monitoring and operation for regular-system equipment and the safety-system equipment;
a controller to which operation signals from the safety-system operation terminal and the regular-system operation terminal are inputted, and which outputs a control signal to plant equipment including the safety-system equipment and the regular-system equipment;
a safety system network which transmits the operation signal from the safety-system operation terminal to the controller; and
a regular system network which transmits the operation signal from the regular-system operation terminal to the controller, wherein
the controller has a function of disabling the operation signal transmitted from the regular system network when the monitoring and operation for the safety-system equipment are performed from the safety-system operation terminal,
the safety-system operation terminal includes a block signal transmitter,
the controller disables the operation signal transmitted from the regular system network, on the basis of a block signal transmitted from the block signal transmitter,
the controller includes a safety-system communication module which receives the operation signal transmitted via the safety system network, a regular-system communication module which receives the operation signal transmitted via the regular system network, and a calculation module which calculates the control signal for controlling the plant equipment, and
the controller disables the operation signal transmitted from the regular system network, by stopping transfer of data from the regular-system communication module to the calculation module on the basis of the block signal.

2. (canceled)

3. A plant control system comprising:
a safety-system operation terminal for performing monitoring and operation for safety-system equipment;
a regular-system operation terminal for performing monitoring and operation for regular-system equipment and the safety-system equipment;
a controller to which operation signals from the safety-system operation terminal and the regular-system operation terminal are inputted, and which outputs a control signal to plant equipment including the safety-system equipment and the regular-system equipment;
a safety system network which transmits the operation signal from the safety-system operation terminal to the controller; and
a regular system network which transmits the operation signal from the regular-system operation terminal to the controller, wherein
the controller has a function of disabling the operation signal transmitted from the regular system network when the monitoring and operation for the safety-system equipment are performed from the safety-system operation terminal,
further comprising a block signal terminal connected to the controller via a wire, wherein
the controller disables the operation signal transmitted from the regular system network, on the basis of a block signal transmitted from the block signal terminal,
the controller includes a safety-system communication module which receives the operation signal transmitted via the safety system network, a regular-system communication module which receives the operation signal transmitted via the regular system network, and a calculation module which calculates the control signal for controlling the plant equipment, and
the controller disables the operation signal transmitted from the regular system network, by stopping transfer of data from the regular-system communication module to the calculation module on the basis of the block signal.

4-5. (canceled)
